(19) United States
(12) Patent Application Publication
(10) Pub. No.: US 2024/0243402 A1
(43) Pub. Date: Jul. 18, 2024

(54) INSULATING ASSEMBLY PARTS FOR BATTERIES COMPRISING FLUOROPOLYMERS

(71) Applicant: SOLVAY SPECIALTY POLYMERS ITALY S.P.A., Bollate (Milano) (IT)

(72) Inventors: Pasqua Colaianna, Milano (IT); Giambattista Besana, Mariano Comense (IT); Gaetano Calvaruso, Pforzheim (DE); Giorgio Canil, Monza (mb) (IT); Luigi Giraldi, Bussero (mi) (IT); Claudia Manzoni, Bologna (IT)

(73) Assignee: SOLVAY SPECIALTY POLYMERS ITALY S.P.A., Bollate (Milano) (IT)

(21) Appl. No.: 18/560,352

(22) PCT Filed: May 6, 2022
(86) PCT No.: PCT/EP2022/062373

§ 371 Date: Nov. 10, 2023

(30) Foreign Application Priority Data
May 12, 2021 (EP) 21173659.0

(51) Int. Cl. H01M 50/193; H01M 50/586; H01M 50/593

(52) U.S. Cl. CPC H01M 50/193; H01M 50/586; H01M 50/593

(57) ABSTRACT

The invention pertains to an insulating assembly part for an electrochemical cell comprising one or more fluoropolymers, said fluoropolymers comprising —87-99% by moles of recurring units derived from tetrafluoroethylene (TFE) —1-13% by moles of recurring units derived from perfluoro methyl vinyl ether (PMVE) —0-3% by moles of recurring units derived from perfluoropropyl vinyl ether (PPVE) and having a melt flow rate (MFR) of from 40 to 300 g/10 min (measured at 372° C. under a 5 kg load).

### TECHNICAL FIELD

This application claims priority to the European Patent Application N. Nr 21173659.0 filed on 12 May 2021, the whole content of this application being incorporated herein by reference for all purposes.

The invention pertains to insulating assembly parts used in the construction of electrochemical cells, in particular for use in secondary batteries, comprising certain selected copolymers of tetrafluoroethylene(TFE) and perfluoroalkylvinylethers (PAVE), to a method of making such insulating assembly parts via injection molding and to electrochemical cells comprising such insulating assembly parts.

### BACKGROUND ART

As known to a skilled person, batteries contain one or more individual electrochemical cells which are capable to convert chemical energy into electrical energy. Some batteries can only be used once, while others can be recharged by converting electrical energy into chemical energy which can then be released again as electrical energy when the battery is used. These are called “rechargeable batteries” or “secondary batteries”. Rechargeable batteries in particular are getting more and more attention in the industry due to the current interest for electrical engines.

Each electrochemical cell typically comprise a number of “active” elements which participate directly to the energy conversion process: a positive electrode, a negative electrode, a porous separator and an electrolyte which is typically liquid but also be in gel or solid form. Commercial batteries typically pack one or more electrochemical cells within a container.

Beyond the mentioned active components, electrochemical cells also contain other assembly parts which are not per se active, but are necessary and extremely important in order to ensure the proper construction and performance of the cell. Each cell must in fact be electrically isolated from other cells by a cell case, and positive and negative terminals must also be available outside the cell case allowing the connection of the cell. In typical cell constructions such as cylindrical cells or prismatic cells this is achieved by using cell caps which typically include a safety vent to avoid bulging of the cell in case gas are formed internally. A sealing and insulating gasket is typically present around the caps or closures to seal the cell to prevent leaking of the electrolytes and entering of moisture, being in contact with active components of the cell the gasket must also be made of electrically insulating material. Furthermore insulator plates are typically present at both sides of the electrodes in order to prevent unwanted short circuits, naturally also insulator plates must be made from electrically insulating materials. Other insulating assembly parts such as electrode holders (also referred to as current collector holders) are typically present in many electrochemical cells constructions as known the skilled person. Constructions can vary and in some cases the same part can perform more than one function and in other cases more individual parts may be used to perform a single function. All these insulating assembly parts have in common being electrical insulators, being essentially inert with respect to the chemicals present in the electrochemical cells and to not participate directly to the electrochemical reactions which make the cell work in accumulating and/or releasing energy.

All these assembly parts are crucial to the life and safety of the cell as the failure of even one single part may cause leakage or short circuit. In particular, assembly parts made of insulating materials are in direct contact with the electrodes and/or with the solvents which are present in the electrolyte materials and are exposed to continuous temperature variations during the battery life. Therefore these insulating assembly parts must be manufactured using materials which are not only electrically insulating, but also able to withstand elevated temperature, temperature changes, and contact with solvents and aggressive chemicals. Insulating assembly parts must also be flexible enough to ensure sealing and separation even when pressure or mechanical stress is applied repeatedly for a long time.

For this reason, high performance plastic materials are typically preferred for most insulating assembly parts in electrochemical cells, especially in cells for secondary batteries which must ensure long service life even under harsh environments.

Among these insulating assembly parts one part which has a particularly great importance in electrochemical cells construction is the so called “gasket” or “sealing gasket”.

Gaskets are seals typically placed around the battery cap to prevent electrolyte from leaking out and moisture in the air from infiltrating the battery. The sealing gaskets also provide electrical insulation to prevent the positive and negative electrodes from making contact and causing short circuits. To ensure the safety and life-span of the batteries, sealing and insulation functions of sealing gaskets (for examples for automotive use) must be guaranteed for 15 years or more of continuous use. The sealing gasket material must possess restoring force to maintain the effectiveness of the seal under adverse conditions, such as high temperatures and long-term stress, which can cause creep deformation, and must maintain these properties for the entire lifetime of the battery.

Another important insulating assembly part is the so called “insulation plate” which is a plastic sheet used to prevent short circuit between two conductors. For example, there are typically two insulation plates in a cylindrical cell. The first plate is located between the bottom of the jellyroll and the bottom of the can. The second plate is located between the top of the jellyroll and the sealing gasket. As known to the skilled person insulator plates are often included in many different battery cells constructions with the same function.

Electrode holders typically are used to maintain electrode plates in the right position and to prevent short circuit. As mentioned above, insulating assembly parts for electrochemical cells must be endowed with outstanding mechanical and chemical properties, and to maintain those properties for a long time. For this reason fluoropolymers and in particular perfluorinated polymers have been used to form such insulating assembly parts.

Polytetrafluoroethylene based thermoplastic materials satisfy all the requirements for forming battery insulating assembly parts. There is ample disclosure in the prior art of the use of copolymers of TFE and PAVE for forming such insulating assembly parts, in particular using TFE/perfluoropropylvinylether (PPVE) copolymers commercially known as PFA.

For example WO13115374 by Daikin describes a sealing material for use in insulating assembly parts for batteries which is based on TFE/PPVE copolymers having a MFR of about 4 g/10 min at 372° C.

Insulating assembly parts for electrochemical cells can be manufactured from fluoropolymers using melt processing techniques such as compression molding and injection molding. Injection molding is particularity preferred because it allows using multi cavity molds thus allowing the preparation of several insulating assembly parts with a single injection process.

As known to the people skilled in the art of molding, a thermoplastic material for injection molding is preferably processable at relatively low temperatures, as both corrosion of the equipment and molds and energy consumption are lower. Also preferred materials for injection molding have a low viscosity at the processing temperature, so that molds with more cavities can be filled without errors, and should also be injectable in the mold at high speed without forming surface defects on the finished object.

On the other hand, while it is known that the viscosity and the melting point of a TFE/PPVE copolymer (such as those used in the cited prior art) can be reduced by increasing the content in PPVE, it is also known that such copolymers with high PPVE content are not suitable for the intended application because a low viscosity is accompanied by reduced mechanical properties and also a reduced thermal stability.

Thermal stability is also very relevant for the injection molding of fluoropolymers, not only for the stability of the polymer itself, but also because a weight loss typically involves loss of various compounds including fluoridric acid (HF) in gas form which is a leading cause of corrosion for the expensive equipment used for injection molding, therefore a material losing weight upon heating would also cause a higher corrosion and consequently a shorter lifespan for the molds. Also weight loss may be linked to gas evolution which may cause formation of defects such as bubbles in the molded articles.

Therefore there is still a need for insulating assembly parts for electrochemical cells obtained from a fluoropolymer composition which satisfies all the requirements of mechanical stability, resistance to chemicals, insulating capacity, sealing capacity etc. of known fluoropolymers but which can be injection molded at lower temperature and which are also more thermally stable during molding.

### SUMMARY OF INVENTION

In one aspect the present invention relates to an insulating assembly part for an electrochemical cell comprising one or more fluoropolymers, said fluoropolymers comprising
87-99% by moles of recurring units derived from tetrafluoroethylene (TFE)
1-13% by moles of recurring units derived from perfluoro methyl vinyl ether (PMVE)
0-3% by moles of recurring units derived from perfluoropropyl vinyl ether (PPVE)
and having a melt flow rate (MFR) of from 40 to 300 g/10 min (measured at 372° ° C. under a 5 kg load).

In another aspect, the present invention relates to a method of making an insulating assembly part for an electrochemical cell, said method including forming said insulating assembly part via injection molding of a thermoplastic polymeric composition said composition comprising one or more fluoropolymers as defined above.

In a further aspect the present invention relates to a secondary battery comprising such insulating assembly parts preferably as sealing gaskets insulator plates or electrode holders.

### DETAILED DESCRIPTION OF THE INVENTION

For the purpose of the present description the term “insulating assembly part” referred to an electrochemical cell indicates all solid components of an electrochemical cell which do not take part to the electrochemical reaction (i.e. electrodes, electrolyte and separator) and which do not conduct electricity (i.e. excluding connectors, wiring etc.). These are for example, sealing gaskets, insulators, seals, electrode holders (also referred to as current collector holders), insulating cases insulating barriers etc. The electrochemical cell is typically a cell for a battery, preferably a secondary battery cell and more preferably a Lithium battery cell. The insulating assembly part is preferably a sealing gasket, an insulator plate and/or an electrode holder.

All percentages or recurring units by moles are referred to the total amount of recurring units present in the polymer.

As mentioned above, the present invention relates to an insulating assembly part for an electrochemical cell, typically a battery cell, such assembly part comprising one or more selected TFE/PAVE fluoropolymers.

The TFE/PAVE fluoropolymers selected for the present invention comprise 1-13%, preferably 1-10%, more preferably 2-8%, even more preferably 3-7% by moles of recurring units derived from perfluoro methyl vinyl ether (PMVE).

The TFE/PAVE fluoropolymers selected for the present invention may also comprise 0-3%, preferably 0-2.5%, more preferably 0-2%, even more preferably 0.1-1.5% by moles of recurring units derived from perfluoropropyl vinyl ether (PPVE).

In general it is preferred that the molar amount of recurring units derived from PPVE (if at all present) is smaller than the molar amount of recurring units derived from PMVE, i.e the molar ratio between recurring units derived from PPVE and recurring units derived from PMVE (PPVE/PMVE) is less than 1, preferably less than 0.5, more preferably less than 0.3, most preferably less than 0.2.

Optionally the TFE/PAVE copolymers for use in the present invention may comprise up to 6%, of recurring units derived from cyclic monomers selected from perfluoro(2,2-dimethyl-1,3-dioxole) of formula (20A), perfluoro(1,3-dioxole) of formula (21A), and 2,2,4-trifluoro-5-trifluoromethoxy-1,3-dioxole of formula (26A):

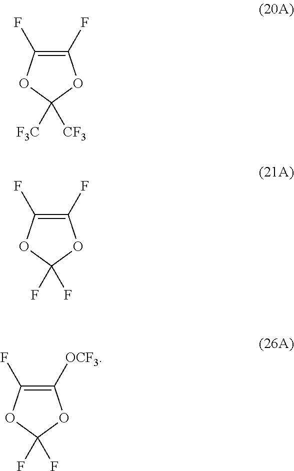

When present such cyclic monomers are preferably from 0.1 to 5% by moles, more preferably from 0.1 to 4% by moles, even more preferably from 0.1 to 3% by moles.

The TFE/PAVE fluoropolymers selected for the present invention comprise recurring units derived from TFE in an amount from 87 to 99% by moles. Other recurring units beyond those derived from TFE, PAVE and the cyclic monomers mentioned above are preferably absent, but, if present are preferably fully fluorinated and preferably below 2% by moles based on the total amount of recurring units of the fluoropolymer.

End chains, impurities, defects and minor amount of other comonomers (these latter in amounts generally not exceeding 0.5%, preferably not exceeding 0.1%, with respect to the total amount of moles of recurring units of the polymer) may be present, without these substantially affecting the properties of the said TFE/PAVE copolymer.

The TFE/PAVE fluoropolymers selected for the present invention are further characterized by having a melt flow rate (MFR) of from 40 to 300, preferably from 50 to 200, more preferably from 60 to 160, even more preferably from 70 to 130 g/10 min (measured at 372° C. under a 5 kg load).

The TFE/PAVE fluoropolymers selected for the present invention are preferably further characterized by a melting point Tₘ, determined according to ASTM D3418 comprised from 260° C. to 310° C., preferably from 270° C. to 305° C., more preferably from 275° C. to 300° C.

The insulating assembly part of the invention is preferably made of a composition which is preferably a thermoplastic polymeric composition wherein the selected TFE/PAVE fluoropolymers described above make up at least 80%, preferably at least 90%, more preferably at least 95%, most preferably at least 99% by weight of said insulating assembly part.

Additional optional ingredients which may be added to the composition used to make the assembly part of the invention are conventional additives such as stabilizing additives, mold release agents, plasticizers, lubricants, thermal stabilizers, light stabilizers, antioxidants, adhesion promoters, fillers, pigments and others which are preferably present in an amount of less than 10% by weight of the composition.

If present the filler can be selected for example from the mineral fillers such as talc, mica, kaolin, calcium carbonate, calcium silicate, magnesium carbonate, graphite, carbon black.

The Applicant has surprisingly found that when an insulating assembly part is made comprising the selected TFE/PAVE fluoropolymers described above, manufacturing is possible via injection molding at a lower temperature and faster injection speed than using the TFE/PPVE fluoropolymers of the prior art, this allows the use of multicavity molds which is a particularly efficient way to manufacture such insulating assembly parts. The use of the selected TFE/PAVE polymers of the invention is also associated with a reduced weight loss and consequent reduced evolution of outgassing species including HF during molding which leads to longer service life for the molds and reduced defects in the molded articles. The insulating assembly parts of the invention have comparable mechanical properties, chemical resistance and stability over time compared with similar assembly parts obtained using TFE/PPVE polymers according to the prior art. Reference is made to the Experimental part below for experimental data supporting the benefits provided by the present invention.

### Method of Making the Article

The present invention also relates to a method of making an insulating assembly part for an electrochemical cell. The method includes forming an insulating assembly part for use in electrochemical cells via injection molding of a thermoplastic polymeric composition said composition comprising one or more selected TFE/PAVE fluoropolymers as described above.

In the method of the invention the mold is preferably a multicavity mold, more preferably a multicavity mold with at least 4 cavities wherein each cavity allows molding an individual insulating assembly part. The low viscosity of the composition allows fast filling of multiple cavities efficiently under mild conditions of temperature and pressure generating individual molded articles which have smooth surface and are free from defects.

Alternatively, but less preferably, the insulating assembly parts of the invention can be manufactured via compression molding, or other melt-processing techniques different from injection molding.

The step of injection molding generally uses a ram or screw-type plunger to force the molten thermoplastic composition into a mold cavity; within the cavity of the said mold, the composition solidifies into a shape that has conformed to the contour of the mold which can be a single cavity mold or a multiple cavities mold.

As mentioned above the injection molding process is preferably conducted using a thermoplastic composition comprising at least 80%, preferably at least 90%, more preferably at least 95%, most preferably at least 99% by weight of one or more of the selected TFE/PAVE fluoropolymers described above.

The injection molding process herein described is particularly suitable for the manufacturing of insulating assembly parts such as sealing gaskets and insulator plates collector holders and the like. Typical shapes for insulating assembly parts of the invention can be varied depending on the geometry of the electrochemical cell. Exemplary shapes are e.g. flat parts (rectangular or disk shaped) having a thickness of 0.2-1 mm, disks, plates, o-rings, sticks and the like.

Should the disclosure of any patents, patent applications, and publications which are incorporated herein by reference conflict with the description of the present application to the extent that it may render a term unclear, the present description shall take precedence.

The invention will now be described in more details with reference to the following examples whose purpose is merely illustrative and not intended to limit the scope of the present invention.

### EXPERIMENTAL SECTION

### Test Methods

MFR: (melt flow rate) has been measured according to ASTM 1238 at 372° C., under a piston load of 5 kg, and is expressed as g/10 min.

TGA: weight loss tests have been performed according to ISO 11358 using a TGA5500 instrument by TA.

### Determination of Melting Point

The melting point Tₘ was measured as second melting temperature via DSC according to ASTM D 3418 standard. The procedure was as follows: Polymer samples were melted heating them from 10 to 400° C. with a temperature ramp of 10° C./min. The samples were then maintained at 400° C. for 5 minutes, and then recrystallized decreasing the temperature from 400° ° C. to 10° C. with a ramp of 10° C./min. The polymer was then kept 10 min at 10° C. and then heated again to 400° C. with a temperature ramp of 10° C./min. The melting point was determined as the temperature of fusion during this second ramp.

C-set (compression set): Compression-set values have been measured following ASTM 395B. Samples were obtained from injection molded disks having outer diameter of 120 mm and thickness 2 mm prepared by injection molding according to the procedure described below. From these larger disks, smaller disks shaped samples were cut having a diameter of 13 mm and thickness 2 mm. These smaller disks were subject to the compression test. In the compression test samples were compressed along the thickness which was originally 2 mm, compressing it down to 1 mm. Samples were kept under compression in an oven at 70° C. for 120 hrs. After this time samples were taken out of the oven, compression was removed and, after 30 minutes of room temperature conditioning, the thickness of the samples was measured. The C-set value was determined by the following equation:

$$C - set ( \% ) = [ ( {t}_{0} - {t}_{i} ) / {t}_{0} - {t}_{s} ) ] \times 100$$

tₒ=original thickness of the specimen (in this case about 2 mm)
tₛ=target compressed thickness of the specimen (in this case 1 mm)
tᵢ=final thickness of the specimen after room temperature conditioning

Tensile properties: Yield stress was measured (in MPa) at 1% off-set at 23° C. on molded plaques according to ASTM D3307. The polymers under test in form of pellets were submitted to melt compression molding at 360° C. in a vertical press for the manufacture of plaques having a thickness of about 1.2 mm.

Dielectric properties: Dielectric strength according to ASTM D149 and CTI (Comparative tracking index) according to ASTM D3638 were obtained on the same molded plaques used for measuring the tensile properties,

Capillary test (sharkskin detection): was performed according to ASTM D 3835. The test was carried out in a capillary rheometer equipment (Rheograph 2003) using L/D=10 and D=1 & 0.54 mm. The molten material was extruded trough the capillary and the surface of the extrudate was evaluated for its smoothness/roughness. The test was used to evaluate which is the maximum shear rate at which the material can be extruded (at a given T) without showing surface roughness. The formation of surface roughness (sharkskin) is immediately evident to a skilled person performing the capillary test by simple tactile inspection of the sample.

### Materials Used:

Polymer P1 (according to the invention)—A TFE/PPVE/PMVE copolymer comprising 4.75% by moles of PPMVE, 0.39% by moles PPVE and 94.86% by moles TFE, having a Tₘ of 281° C., and MFR at 372° C.-5 kg of 88 g/10 min.

Polymer P2 (comp)—A TFE/PPVE copolymer comprising 1.6% by moles of PPVE, and 98.4% by moles of TFE having a Tₘ of 308° C. and having an MFR at 372° C.-5 kg of 13.3 g/10 min.

### Preparation of Polymer P1

In a 22 liters AISI 316 steel vertical reactor, equipped with stirrer working at 400 rpm the following ingredients were introduced in sequence after vacuum has been made:
13.9 It of demineralized water,
85 g of perfluoropropylvinylether (PPVE)
128 g of a microemulsion prepared in accordance to U.S. Pat. No. 4,864,006 by mixing 39.7 g of one ionic perfluoropolyether having ammonium carboxylate end groups, 23 g of one perfluoropolyether having neutral end groups and 65.3 g water.

Once all ingredients had been added, the reactor was heated up to 75° C. and 0.15 bar of Ethane and 3.7 bar of perfluoromethylvinylether (PMVE) were fed. Then a gaseous TFE/PMVE mixture in molar ratio of 21 was added by compressor until a pressure of 21 absolute bar was reached. By a metering pump 118 ml of Ammonium Persulfate solution 0,044 M was fed thus starting the polymerization. The polymerization pressure was kept constant by feeding the aforesaid monomeric mixture and when 20% of conversion was reached an additional amount of 8.6 g of Ethane was added. After feeding 8715 g total of the above mixture the monomer mixture feeding was interrupted, stirring was stopped and pressure was let decrease until it reached 7.5 absolute bar. The reactor was then cooled at room temperature, the emulsion was discharged and coagulated with nitric acid 65% solution. The polymer was washed with water, dried in oven at 220° C. and then pelletized using a Coperion twin screw extruder 48D at an extrusion temperature of about 302° C. The nominal polymeric composition was PMVE 4.75% by moles, PPVE 0.39% by moles and TFE 94.86% by moles. MFR was 88 g/10′ and Melting point 281° C.

Injection molding of polymer P1 and P2: The polymers P1 and P2 were used to prepare disks having diameter of 120 mm and thickness of 2 mm via injection molding. The molding was performed on an injection-molding machine Negri-Bossi (NB100) with barrel diameter of 30 mm. The disks obtained by injection molding have been used for C-set measurement as mentioned above.

The molding condition were optimized for both polymer P1 and P2: polymer P1 (according to the invention) was processed in the injection molding machine at a cylinder temperature of C1/C2/C3/C4 of 315/320/325/330° ° C., nozzle temperature 330° C. and up to a pressure (hold pressure) of 432 bar, while polymer P2 (comparative) was processed in the injection molding machine at a cylinder temperature of C1/C2/C3/C4 of 370/375/380/385° C., nozzle temperature 385° C. and up to a pressure (hold pressure) of 520 bar. Both molding operations required a cycle time of 65 seconds.

Both disks obtained were perfectly smooth and free from cracks or defects. This molding example shows how Polymer P1 can be injection molded at lower temperature and pressures than polymer P2.

### Measurement of Yield Stress

Yield stress was measured on molded plaques obtained as described above. Results obtained show that samples of both polymer P1 and P2 have the same yield stress of about 12.5 MPa.

### Measurement of Compression Set (C-Set)

C-set was measured on samples of both polymer P1 and P2 prepared from the molded disks as described above. Results showed that both samples have the same C-set value of about 73%. The test pieces after compression didn't present defects or cracks.

### Measurement of Dielectric Properties

Dielectric strength and CTI were measured on the same molded plaques used for the measurement of mechanical properties. Results obtained show that samples of both polymer P1 and P2 have the same dielectric strength of about 32 KV/mm and a CTI above 600 V.

### Capillary Test

Both polymers P1 and P2 were subject to the capillary test. The molten polymer was injected in the capillary of the instrument and extruded trough it at various temperatures. The surface of the extruded material was evaluated if smooth (pass) and rough (fail). The maximum shear rate at which the polymer showed smooth surface at each temperature was recorded as “sharkskin onset shear rate”. Results are shown in Table 1.

TABLE 1

| Sample | Temperature (° C.) | Sharkskin onset shear (s⁻¹) |
|---|---|---|
| P2 | 350 | 29 |
| | 372 | 49 |
| | 400 | 83 |
| P1 | 350 | 240 |
| | 372 | 700 |
| | 400 | 1200 |

The results clearly show how polymer P1, selected according to the invention, can be injection molded at a much faster rate than polymer P2 without risk of formation of surface defects.

### Measurement of Weight Loss

Weight loss was measured on a 0.030 g sample in a TGA5500 instrument by TA. Two weight loss tests were performed. In the first test polymer samples were heated from room temperature up to 380° ° C. with a temperature ramp of 10° C. per minute (Dynamic heating test).

In the second test the polymer samples were heated with the same ramp to their molding temperature (330° C. for P1 and 380° ° C. for P2) and the temperature was maintained for 4 hours (Isothermal test).

Weight loss data are reported in the following table 2:

TABLE 2

Weight loss

| | P1 | P2 |
|---|---|---|
| Dynamic heating test | 0.075% wt | 0.15% wt |
| Isothermal test | 0.25% wt | 0.90% wt |

The weight loss data show how the sample of Polymer P1 exhibit a reduced weight loss after dynamic heating up to 380° C. This implies a reduced evolution of decomposition products including HF gas during molding and therefore a longer service life for the equipment and reduced numbers of defects (e.g. bubbles) in the molded articles. To note, in real life application the molding temperature of polymer P1 is much lower than the molding temperature of P2 which implies an even more marked reduction in the evolution of decomposition products as shown by the Isothermal weight loss test.

### Preparation of Insulating Assembly Parts for Electrochemical Cells

Ex. Preparation of an Insulator Plate

Polymer P1 was processed in an injection-molding machine. The melt was injected in a multi cavity mold having 4 cavities in the shape of disks having a diameter of 8 mm and a thickness of 0.5 mm. All the rings were well formed, smooth and free of cracks or defects. The disks were then used as insulator plates for cylindrical Li cells.

Overall the data shows how using the selected polymers of the invention to manufacture insulating assembly parts for batteries allows to efficiently make these part via injection molding, using a lower molding temperature, a faster injection molding process (as the molten polymer can be subject to a higher shear rate) and registering a lower weight loss (corresponding to a lower level of corrosive outgassing) during molding with respect to common PFA polymers used in the art for the same application. Surprisingly the resulting parts have mechanical and electrical properties which are in line with those of the PFA polymers traditionally used.

1. An insulating assembly part for an electrochemical cell comprising one or more fluoropolymers, said fluoropolymers comprising:
87-99% by moles of recurring units derived from tetrafluoroethylene (TFE)
1-13% by moles of recurring units derived from perfluoro methyl vinyl ether (PMVE)
0-3% by moles of recurring units derived from perfluoropropyl vinyl ether (PPVE) and having a melt flow rate (MFR) of from 40 to 300 g/10 min (measured at 372° C. under a 5 kg load).

2. The insulating assembly part according to claim 1 wherein said one or more fluoropolymers comprise:
1-10% by moles of recurring units derived from PMVE
0-3% by moles of recurring units derived from PPVE.

3. The insulating assembly part according to claim 1 wherein said one or more fluoropolymers have a molar ratio between recurring units derived from PPVE and recurring units derived from PMVE (PPVE/PMVE) which is less than 1.

4. The insulating assembly part according to claim 1 wherein said one or more fluoropolymers have a melting temperature Tₘ of from 260° ° C. to 310° C.

5. The insulating assembly part according to claim 1 wherein said one or more fluoropolymers have a MFR of from 50 to 200 g/10 min (measured at 372° ° C. under a 5 kg load).

6. The insulating assembly part according to claim 1 wherein said one or more fluoropolymers make up at least 80% by weight of said insulating assembly part.

7. The insulating assembly part according to claim 1 wherein said electrochemical cell is a battery cell.

8. The insulating assembly part according to claim 1 which is an injection molded insulating assembly part.

9. The insulating assembly part according to claim 1 which is a sealing gasket, an insulator plate or an electrode holder.

10. A method of making an insulating assembly part for an electrochemical cell according to claim 1, said method including forming said insulating assembly part via injection molding of a thermoplastic polymeric composition into a mold, said composition comprising one or more fluoropolymers comprising:
87-99% by moles of recurring units derived from tetrafluoroethylene (TFE)
1-13% by moles of recurring units derived from perfluoro methyl vinyl ether (PMVE)
0-3% by moles of recurring units derived from perfluoropropyl vinyl ether (PPVE) and having a melt flow rate (MFR) of from 40 to 300 g/10 min (measured at 372° C. under a 5 kg load).

11. The method of making an insulating assembly part for an electrochemical cell according to claim 10 wherein said mold is a multicavity mold comprising at least 4 cavities each cavity allowing the molding of an individual insulating assembly part.

12. The method of making an insulating assembly part for an electrochemical cell according to claim 10 wherein said thermoplastic composition comprises at least 80% by weight of said one or more fluoropolymers.

13. A secondary battery comprising at least one insulating assembly part according to claim 1.

14. The secondary battery according to claim 13 wherein said at least one insulating assembly part is a sealing gasket, an insulator plate and/or an electrode holder.

15. (canceled)
